(19) United States
(12) Patent Application Publication
(10) Pub. No.: US 2022/0395939 A1
(43) Pub. Date: Dec. 15, 2022

(54) METHOD OF ATTACHING DIAPHRAGM MEMBER TO DIAPHRAGM BOSS AND ROBOT ARM APPARATUS CONFIGURED TO ATTACH DIAPHRAGM MEMBER TO DIAPHRAGM BOSS

(71) Applicant: SHINWA CONTROLS CO., LTD, Kawasaki-Shi (JP)

(72) Inventor: Hirotaka IKEGAMI, Kawasaki-Shi (JP)

(73) Assignee: SHINWA CONTROLS CO., LTD, Kawasaki-Shi (JP)

(21) Appl. No.: 17/756,261

(22) PCT Filed: Dec. 16, 2020
(86) PCT No.: PCT/JP2020/047009

§ 371 Date: May 20, 2022

(30) Foreign Application Priority Data
Dec. 18, 2019 (JP) 2019-228367

(51) Int. Cl. B23P 19/02; B25J 9/16

(52) U.S. Cl. CPC B23P 19/02; B25J 9/16

(57) ABSTRACT

The diaphragm boss is fixed such that the shaft part and the enlarged-diameter part are exposed upwardly. The diaphragm member is held with an air suction force by a robot arm apparatus having an air suction part such that the small-diameter concave part and the large-diameter concave part are exposed downwardly. By controlling the robot arm apparatus, the diaphragm member is brought into contact with the diaphragm boss while tilting an axis of the diaphragm member with respect to an axis of the diaphragm boss. By controlling the robot arm apparatus, the small-diameter concave part and/or the large-diameter concave part of the diaphragm member are pressed against the diaphragm boss while rotating the diaphragm member around the axis of he diaphragm boss, so that the enlarged-diameter part is fitted into the large-diameter concave part and the shaft part is fitted into the small-diameter concave part.

### TECHNICAL FIELD

The present invention relates to a method of attaching a diaphragm member to a diaphragm boss and to a robot arm apparatus configured to attach a diaphragm member to a diaphragm boss.

### BACKGROUND ART

Conventionally, a diaphragm type of solenoid valve has been used for controlling a flow or a stop of a fluid.

For example, as shown in FIG. 10, a conventional diaphragm type of solenoid valve includes: a solenoid valve main body 110 having a diaphragm seating surface 112 in which flow channels 110a, 110b are opened; a diaphragm member 120 configured to be seated on the diaphragm seating surface 112 of the solenoid valve main body 110; a diaphragm boss 130 holding the diaphragm member 120; a movable core (not shown in FIG. 10) integrated with the diaphragm boss 130; and a coil containing body (not shown in FIG. 10) configured to apply an electromagnetic force to the movable core in order to move the movable core in a direction away from the diaphragm seating surface 112 of the solenoid valve main body 110 such that the diaphragm member 120 is released from the diaphragm seating surface 112.

In detail, the diaphragm member 120 includes: a cylindrical main body 123; a thinner curved part 124 which is annularly provided on an outer side than the cylindrical main body 123; and a thicker outer peripheral part 125 which is annularly provided on a further outer side than the thinner curved part 124. The cylindrical main body 123 includes: a small-diameter concave part 122 on an attaching surface side facing to the diaphragm boss 130; and a large-diameter concave part 121 on a side deeper than the small-diameter concave part 122. The diaphragm boss 130 includes: a shaft part 132 which is capable of fitting in the small-diameter concave part 122; and an enlarged-diameter part 131 which is connected to the shaft part 132 and is capable of fitting in the large-diameter concave part 121.

Conventionally, the diaphragm boss 130 is fitted into (and removable from) the diaphragm member 120 with an aid of an elastic deformation of the diaphragm member 120, by a manual operation of an operator.

The other basic structure of the diaphragm type of solenoid valve has been disclosed in JP-A-2009-257438 (Patent Document 1), for example.

### PRIOR ART DOCUMENT

### Patent Document

Patent Document 1 is JP-A-2009-257438.

Patent Document 2 is JP-A-2019-150915.

### SUMMARY OF INVENTION

### Technical Problem

As described above, a diaphragm boss is fitted into (and removable from) a diaphragm member by a manual operation of an operator.

However, it is expected that a shortage of manpower will become more serious in near future. Under the circumstances, the present inventor has earnestly studied about automation by introducing a robot.

Various types of robot hands for holding a work have been already developed. For example, JP-A-2019-150915 (Patent Document 2) has disclosed a robot hand using a claw type of work-holding part for holding a work.

However, a diaphragm member is such a delicate member that it may be undesirably plastically deformed when an undesired force is applied thereto. On the other hand, a considerable force has to be applied in order to fit a diaphragm boss into the diaphragm member.

As a result of the earnest study, the present inventor has found that holding a diaphragm member by making use of an air suction force is effective to surely hold the diaphragm member while avoiding any undesired deformation thereof. Furthermore, the present inventor has found a suitable manner of applying a fitting force for the diaphragm boss according to which any undesired deformation of the diaphragm member can be surely avoided.

The present invention has been made based on the above findings. The object of the present invention is to provide: a method of attaching a diaphragm member to a diaphragm boss, according to which any undesired deformation of the diaphragm member can be surely avoided; and a robot arm configured to attach a diaphragm member to a diaphragm boss, by which any undesired deformation of the diaphragm member can be surely avoided.

### Solution to Problem

The present invention is a method of attaching a diaphragm member to a diaphragm boss, the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part; the diaphragm boss including: a shaft part which is capable of fitting in the small-diameter concave part; and an enlarged-diameter part which is connected to the shaft part and is capable of fitting in the large-diameter concave part; the method including: (1) fixing the diaphragm boss in such a manner that the shaft part and the enlarged-diameter part are exposed upwardly; (2) holding the diaphragm member with an air suction force by making use of a robot arm apparatus having an air suction part in such a manner that the small-diameter concave part and the large-diameter concave part are exposed downwardly; (3) after the steps of (1) and (2), controlling the robot arm apparatus to bring the small-diameter concave part and/or the large-diameter concave part of the diaphragm member into contact with the enlarged-parameter part of the diaphragm boss while tilting an axis of the columnar main body of the diaphragm member with respect to an axis of the shaft part of the diaphragm boss; and (4) after the step of (3), controlling the robot arm apparatus to press the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, so that the enlarged-diameter part is fitted into the large-diameter concave part and the shaft part is fitted into the small-diameter concave part.

According to the above invention, since the diaphragm member is held by making use of the air suction force, the diaphragm member is surely held while avoiding any undesired deformation thereof. In addition, by bringing the small-diameter concave part and/or the large-diameter concave part of the diaphragm member into contact with the enlarged-parameter part of the diaphragm boss while tilting the axis of the columnar main body of the diaphragm member with respect to the axis of the shaft part of the diaphragm boss, and subsequently by pressing the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, it is possible to fit the enlarged-diameter part into the large-diameter concave part and to fit the shaft part into the small-diameter concave part while avoiding any undesired deformation of the diaphragm member more surely.

In the above invention, it is preferable that the method further includes: (5) controlling the robot arm apparatus to rotate the diaphragm member around the axis of the shaft part of the diaphragm boss in both reciprocal directions in a state wherein the axis of the columnar main body of the diaphragm member is conformed with the axis of the shaft part of the diaphragm boss, after the step of (4).

According to the step of (5), a surface of the enlarged-diameter part on the opposite side of the shaft part can be brought into close contact with a surface of the large-diameter concave part on the deeper side, which can make firmer the fitting between the diaphragm member and the diaphragm boss.

In this case, it is preferable that the method further includes: (6) controlling the robot arm apparatus to tilt again the axis of the columnar main body of the diaphragm member with respect to the axis of the shaft part of the diaphragm boss, and to rotate the diaphragm member around the axis of the shaft part of the diaphragm boss while maintaining a tilting angle formed therebetween, after the step of (5).

According to the step of (6), even when the fitting operation by the steps of (4) and (5) does not function sufficiently, it is possible to fit the enlarged-diameter part into the large-diameter concave part and to fit the shaft part into the small-diameter concave part more surely.

In this case, it is preferable that the method further includes: (7) controlling the robot arm apparatus to rotate the diaphragm member around the axis of the shaft part of the diaphragm boss in the both reciprocal directions in a state wherein the axis of the columnar main body of the diaphragm member is conformed again with the axis of the shaft part of the diaphragm boss, after the step of (6).

According to the step of (7), a surface of the enlarged-diameter part on the opposite side of the shaft part can be brought into close contact with a surface of the large-diameter concave part on the deeper side, which can make firmer the fitting between the diaphragm member and the diaphragm boss (which is substantially the same effects as those by the step of (5)).

In addition, it is preferable that the diaphragm member has a valve sealing surface on an opposite side of the attaching surface side, and that the air suction part is configured to hold the diaphragm member without any contact with the valve sealing surface.

According to this feature, the valve sealing surface, which is important for the performances of the solenoid valve, can be maintained in a state thereof just after the diaphragm member has been finished.

Alternatively, the present invention is a robot arm apparatus configured to attach a diaphragm member to a diaphragm boss, the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part; the diaphragm boss including: a shaft part which is capable of fitting in the small-diameter concave part; and an enlarged-diameter part which is connected to the shaft part and is capable of fitting in the large-diameter concave part; the robot arm apparatus including: an air suction part capable of holding the diaphragm member with an air suction force in such a manner that the small-diameter concave part and the large-diameter concave part are exposed; a robot arm mechanism connected to the air suction part and configured to change a position and a posture of the air suction part; and a controlling part configured to control the robot arm mechanism; the controlling part is capable of execute the steps of: (3) controlling the robot arm mechanism to bring the small-diameter concave part and/or the large-diameter concave part of the diaphragm member into contact with the enlarged-parameter part of the diaphragm boss while tilting an axis of the columnar main body of the diaphragm member with respect to an axis of the shaft part of the diaphragm boss; and (4) after the step of (3), controlling the robot arm mechanism to press the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, so that the enlarged-diameter part is fitted into the large-diameter concave part and the shaft part is fitted into the small-diameter concave part.

According to the above invention, since the diaphragm member is held by making use of the air suction force, the diaphragm member is surely held while avoiding any undesired deformation thereof. In addition, by bringing the small-diameter concave part and/or the large-diameter concave part of the diaphragm member into contact with the enlarged-parameter part of the diaphragm boss while tilting the axis of the columnar main body of the diaphragm member with respect to the axis of the shaft part of the diaphragm boss, and subsequently by pressing the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, it is possible to fit the enlarged-diameter part into the large-diameter concave part and to fit the shaft part into the small-diameter concave part while avoiding any undesired deformation of the diaphragm member more surely.

In the above invention, it is preferable that the controlling part is further capable of execute the step of: (5) after the step of (4), controlling the robot arm mechanism to rotate the diaphragm member around the axis of the shaft part of the diaphragm boss in both reciprocal directions in a state wherein the axis of the columnar main body of the diaphragm member is conformed with the axis of the shaft part of the diaphragm boss.

According to the step of (5), a surface of the enlarged-diameter part on the opposite side of the shaft part can be brought into close contact with a surface of the large-diameter concave part on the deeper side, which can make firmer the fitting between the diaphragm member and the diaphragm boss.

In this case, it is preferable that the controlling part is further capable of execute the step of: (6) controlling the robot arm mechanism to tilt again the axis of the columnar main body of the diaphragm member with respect to the axis of the shaft part of the diaphragm boss, and to rotate the diaphragm member around the axis of the shaft part of the diaphragm boss while maintaining a tilting angle formed therebetween, after the step of (5).

According to the step of (6), even when the fitting operation by the steps of (4) and (5) does not function sufficiently, it is possible to fit the enlarged-diameter part into the large-diameter concave part and to fit the shaft part into the small-diameter concave part more surely.

In this case, it is preferable that the controlling part is further capable of execute the step of: (7) controlling the robot arm mechanism to rotate the diaphragm member around the axis of the shaft part of the diaphragm boss in the both reciprocal directions in a state wherein the axis of the columnar main body of the diaphragm member is conformed again with the axis of the shaft part of the diaphragm boss, after the step of (6).

According to the step of (7), a surface of the enlarged-diameter part on the opposite side of the shaft part can be brought into close contact with a surface of the large-diameter concave part on the deeper side, which can make firmer the fitting between the diaphragm member and the diaphragm boss (which is substantially the same effects as those by the step of (5)).

In addition, it is preferable that the diaphragm member has a valve sealing surface on an opposite side of the attaching surface side, and that the air suction part is configured to hold the diaphragm member without any contact with the valve sealing surface.

According to this feature, the valve sealing surface, which is important for the performances of the solenoid valve, can be maintained in a state thereof just after the diaphragm member has been finished.

In addition, it is preferable that the air suction part is configured to hold the diaphragm boss without any contact with a surface of the enlarged-diameter part on the opposite side of the shaft part.

According to this feature, the surface of the enlarged-diameter part on the opposite side of the shaft part, which is important for the firm fitting between the diaphragm member and the diaphragm boss, can be maintained in a state thereof just after the diaphragm boss has been finished.

Alternatively, the present invention is a robot arm apparatus configured to attach a diaphragm member to a diaphragm boss, the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part; the diaphragm boss including: a shaft part which is capable of fitting in the small-diameter concave part; and an enlarged-diameter part which is connected to the shaft part and is capable of fitting in the large-diameter concave part; the robot arm apparatus including: an air suction part capable of holding the diaphragm member with an air suction force in such a manner that the small-diameter concave part and the large-diameter concave part are exposed; a robot arm mechanism connected to the air suction part and configured to change a position and a posture of the air suction part; and a controlling part configured to control the robot arm mechanism; wherein the air suction part has a lower large-diameter hole and an upper small-diameter hole, which are continuous in a height direction thereof via a stepped part, the diaphragm member is configured to be held with the air suction force in such a manner that the columnar main body is received in the lower large-diameter hole, and the diaphragm member is configured to be in contact with the stepped part in a state wherein the diaphragm member is held with the air suction force.

According to the above invention, since the diaphragm member is held by making use of the air suction force, the diaphragm member is surely held while avoiding any undesired deformation thereof. In addition, it is possible to apply a pressing force against the diaphragm member by making use of the stepped part, and thus it is possible to fit the enlarged-diameter part into the large-diameter concave part and to fit the shaft part into the small-diameter concave part while avoiding any undesired deformation of the diaphragm member more surely.

### Advantageous Effects of Invention

According to one aspect of the present invention, since the diaphragm member is held by making use of the air suction force, the diaphragm member is surely held while avoiding any undesired deformation thereof. In addition, by bringing the small-diameter concave part and/or the large-diameter concave part of the diaphragm member into contact with the enlarged-parameter part of the diaphragm boss while tilting the axis of the columnar main body of the diaphragm member with respect to the axis of the shaft part of the diaphragm boss, and subsequently by pressing the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, it is possible to fit the enlarged-diameter part into the large-diameter concave part and to fit the shaft part into the small-diameter concave part while avoiding any undesired deformation of the diaphragm member more surely.

According to another aspect of the present invention, since the diaphragm member is held by making use of the air suction force, the diaphragm member is surely held while avoiding any undesired deformation thereof. In addition, it is possible to apply a pressing force against the diaphragm member by making use of the stepped part, and thus it is possible to fit the enlarged-diameter part into the large-diameter concave part and to fit the shaft part into the small-diameter concave part while avoiding any undesired deformation of the diaphragm member more surely.

### BRIEF DESCRIPTION OF DRAWINGS

FIG. 1 is a schematic view of a robot arm apparatus according to an embodiment of the present invention,

FIG. 2 is a schematic sectional view of an example of diaphragm member;

FIG. 3 is a schematic sectional view of an example of diaphragm boss, which is one part of a movable core;

FIG. 4 is a schematic sectional view of an example of ground;

FIG. 5 is a schematic view of an air suction part of the robot arm apparatus shown in FIG. 1;

FIG. 6 is a flowchart showing a method according to an embodiment of the present invention;

FIG. 7 is a schematic view showing a state wherein the air suction part holds the movable core including the diaphragm boss;

FIG. 8 is a schematic view showing a state wherein the air suction part holds the diaphragm member;

FIG. 9 is a schematic view showing the diaphragm member fitted to the diaphragm boss; and

FIG. 10 is a schematic sectional view of a diaphragm type of solenoid valve.

### DESCRIPTION OF EMBODIMENTS

An embodiment of the present invention will be described below with reference to the attached drawings.

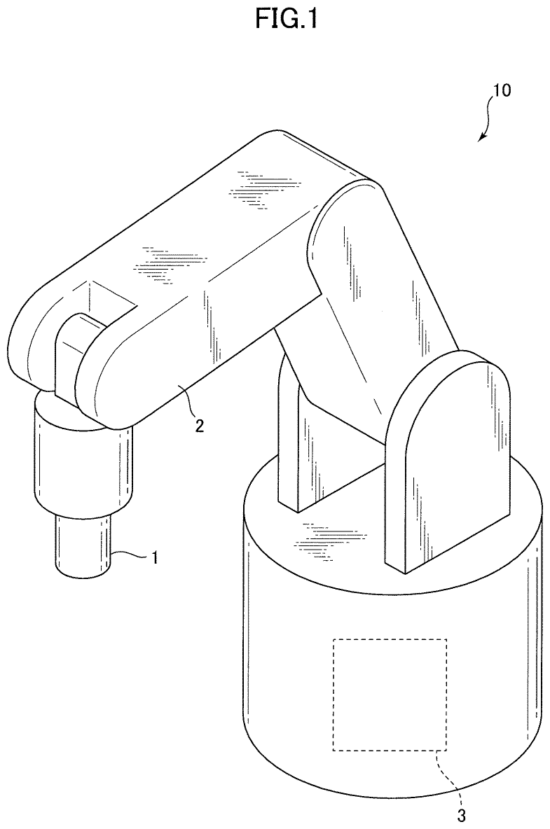

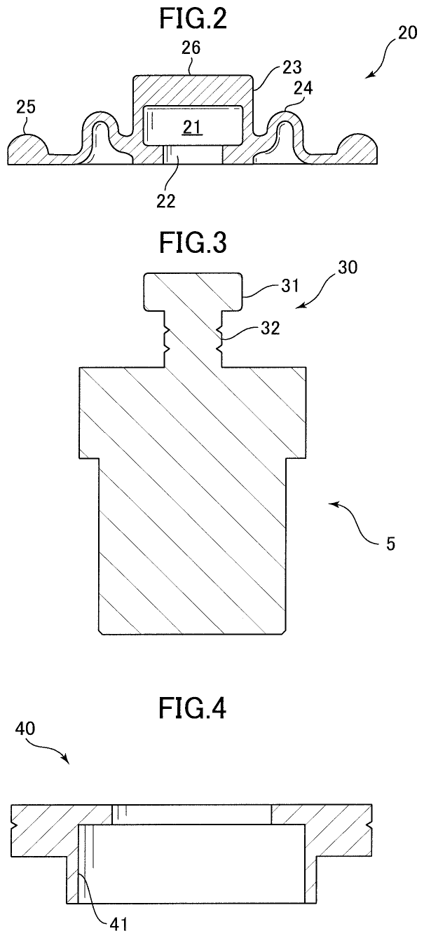

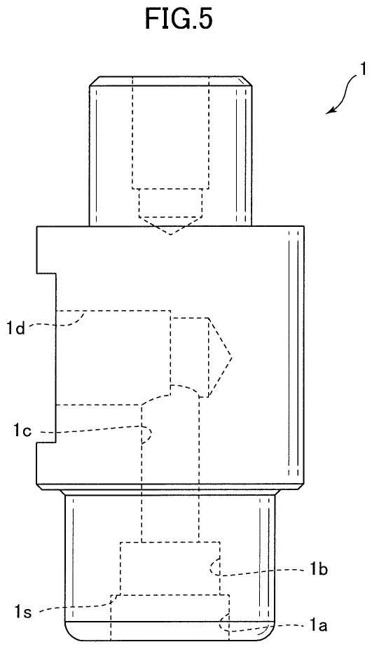

FIG. 1 is a schematic view of a robot arm apparatus according to the embodiment of the present invention, FIG. 2 is a schematic sectional view of an example of diaphragm member, FIG. 3 is a schematic sectional view of an example of diaphragm boss, which is one part of a movable core, FIG. 4 is a schematic sectional view of an example of ground, and FIG. 5 is a schematic view of an air suction part of the robot arm apparatus shown in FIG. 1.

As shown in FIG. 1, the robot arm apparatus 10 of the present embodiment includes: an air suction part 1 capable of holding a diaphragm member 20 or the like with an air suction force; a robot arm mechanism 2 connected to the air suction part 1 and configured to change a position and a posture of the air suction part 1; and a controlling part 3 configured to control the robot arm mechanism 2.

As shown in FIG. 2, the diaphragm member 20 of the present embodiment includes: a cylindrical main body 23 (an example of columnar main body); a thinner curved part 24 which is annularly provided on an outer side than (on an outer periphery of) the cylindrical main body 23; and a thicker outer peripheral part 25 which is annularly provided on a further outer side than the thinner curved part 24. The material of the diaphragm member 20 is, for example, a rubber (fluorine rubber or the like).

The cylindrical main body 23 includes: a small-diameter concave part 22 on an attaching surface side facing to a diaphragm boss 30 which is one part of a movable core 5; and a large-diameter concave part 21 on a deeper side than the small-diameter concave part 22. The surface of the cylindrical main body 23 on the opposite side of an attaching surface side has been finished as a valve sealing surface 26.

The cylindrical main body 23 of the present embodiment has a height of 4.5 mm and a diameter of 6 mm. The thinner curved part 24 has an outer diameter of 14.4 mm and a thickness (height) of about 0.5 mm. The thicker outer peripheral part 25 has an outer diameter of 18.3 mm.

The small-diameter concave part 22 of the present embodiment has a height of 1 mm and a diameter of 3 mm. The large-diameter concave part 21 of the present embodiment has a height of 2 mm and a diameter of 5 mm.

Next, as shown in FIG. 3, the diaphragm boss 30 of the present embodiment is one part of the movable core 5 and includes: a shaft part 32 which is capable of fitting in the small-diameter concave part 22; and an enlarged-diameter part 31 which is connected to the shaft part 32 and is capable of fitting in the large-diameter concave part 21. The material of the diaphragm boss 30 is, for example, a magnetic material (electromagnetic stainless steel or the like).

The shaft part 32 of the present embodiment has a length (height) of 3 mm and a diameter of 3 mm, and is provided with a V-shaped groove for identification. In addition, the enlarged-diameter part 31 of the present embodiment has a height of 2 mm and a diameter of 5.1 mm (the enlarged-diameter part 31 is capable of fitting in the large-diameter concave part 21 by the latter's elastically deforming).

Furthermore, in the present embodiment, an annular member shown in FIG. 4 is used, which is called a ground 40. The ground 40 of the present embodiment has an outer diameter of 18.4 mm and an inner diameter of 8.4 mm. A lower hanging-down part 41 thereof has a length (height) of 2.4 mm, an outer diameter of 13 mm and an inner diameter of 11.8 mm. The height of the ground 40 without the lower hanging-down part 41 is 2.55 mm.

On the other hand, as shown in FIG. 5, the air suction part 1 of the present embodiment has a lower large-diameter hole 1a and an upper small-diameter hole 1b, which are continuous in a height direction thereof via a stepped part 1s. The upper small-diameter hole 1b is connected to an air suction mechanism (not shown) via a vertical hole 1c and a horizontal hole 1d. By an action of the air suction mechanism, the air suction part 1 can hold an object received in the lower large-diameter hole 1a and/or an upper small-diameter hole 1b by making use of a negative pressure. The material of the air suction part 1 is, for example, a hard resin (nylon or the like), in order not to damage the object to be held.

The lower large-diameter hole 1a of the present embodiment has a length (height) of 2.4 mm and a diameter of 6.2 mm, and the upper small-diameter hole 1b of the present embodiment has a length (height) of 2.8 mm and a diameter of 5.2 mm.

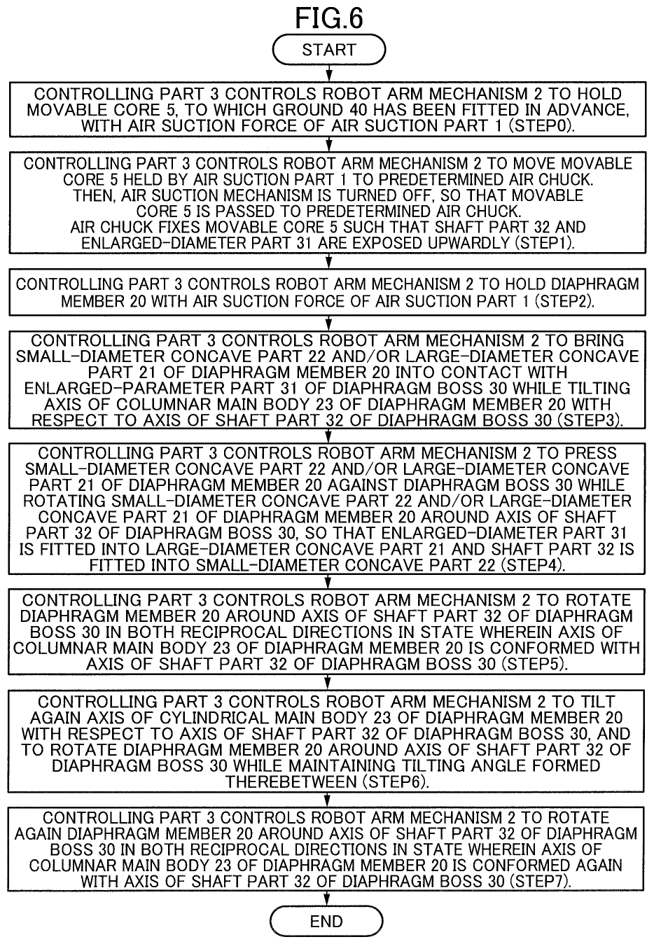

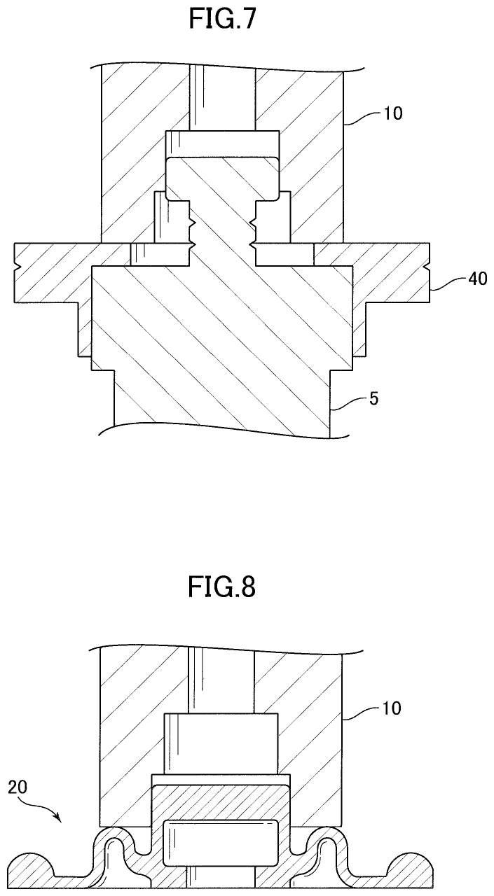

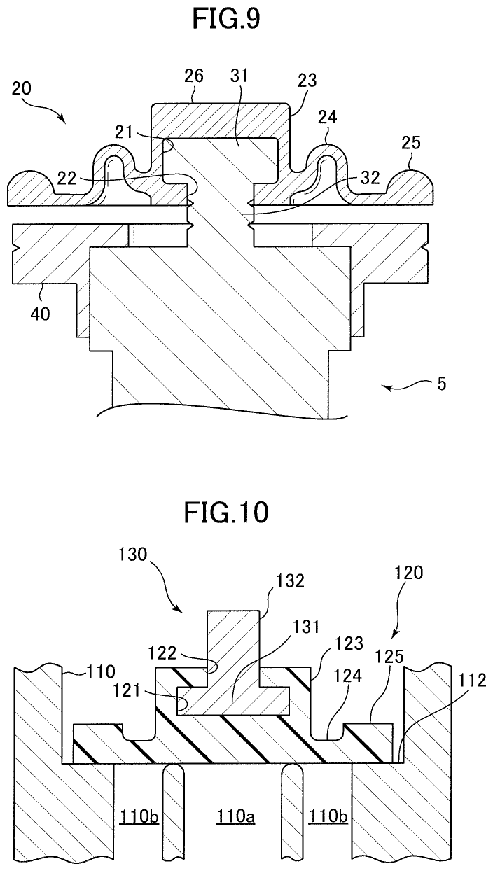

Next, FIG. 6 is a flowchart showing a method according to an embodiment of the present invention, FIG. 7 is a schematic view showing a state wherein the air suction part 1 holds the movable core 5 including the diaphragm boss 30, FIG. 8 is a schematic view showing a state wherein the air suction part 1 holds the diaphragm member 20, and FIG. 9 is a schematic view showing the diaphragm member 20 fitted to the diaphragm boss 30.

In the present embodiment, the controlling part 3 controls the robot arm mechanism 2 to hold the movable core 5, to which the ground 40 has been fitted in advance, with the air suction force of the air suction part 1 (STEP0).

At this time, as shown in FIG. 7, the enlarged-diameter part 31 is almost received in the upper smaller-diameter hole 1b, and thus a negative pressure brought by the air suction mechanism serves as a holding force effectively.

In addition, at this time, the air suction part 1 holds the movable core 5 including the diaphragm boss 30 without any contact with a surface of the enlarged-diameter part 31 on the opposite side of the shaft part 32. According to this feature, the surface can be maintained in a state thereof just after the diaphragm boss 30 has been finished. Therefore, a firm fitting between the diaphragm member 20 and the diaphragm boss 30 can be achieved more effectively.

Next, in the present embodiment, the controlling part 3 controls the robot arm mechanism 2 to move the movable core 5 including the diaphragm boss 30 held by the air suction part 1 to a predetermined air chuck (not shown). Then, the air suction mechanism is turned off, and thus the movable core 5 is passed to the predetermined air chuck. The air chuck fixes the movable core 5 in such a manner that the shaft part 32 and the enlarged-diameter part 31 are exposed upwardly (STEP1).

Nest, in the present embodiment, the controlling part 3 controls the robot arm mechanism 2 to hold the diaphragm member 20 with the air suction force of the air suction part 1 (STEP2)

At this time, as shown in FIG. 8, the cylindrical main body 23 is almost received in the lower large-diameter hole 1 a, and thus a negative pressure brought by the air suction mechanism serves as a holding force effectively.

In addition, at this time, the air suction part 1 holds the diaphragm member 20 without any contact with a valve-sealing surface 26. According to this feature, the surface can be maintained in a state thereof just after the diaphragm member 20 has been finished. Therefore, desired performances as a diaphragm valve can be achieved more surely.

Nest, in the present embodiment, the controlling part 3 controls the robot arm mechanism 2 to bring the small-diameter concave part 22 and/or the large-diameter concave part 21 of the diaphragm member 20 into contact with the enlarged-parameter part 31 of the diaphragm boss 30 while tilting an axis of the columnar main body 23 of the diaphragm member 20 with respect to an axis of the shaft part 32 of the diaphragm boss 30 (for example, a tilting angle therebetween is within 10 to 30 degrees, preferably 20 degrees) (STEP3).

Subsequently, the controlling part 3 controls the robot arm mechanism 2 to press the small-diameter concave part 22 and/or the large-diameter concave part 21 of the diaphragm member 20 against the diaphragm boss 30 while rotating the small-diameter concave part 22 and/or the large-diameter concave part 21 of the diaphragm member 20 around the axis of the shaft part 32 of the diaphragm boss 30 (specifically, for example, the tilting angle is gradually reduced (for example, the tilting angle is reduced to 0 degrees during about three quarter rotation thereof)), so that the enlarged-diameter part 31 is fitted into the large-diameter concave part 21 and the shaft part 32 is fitted into the small-diameter concave part 22 (STEP4). The pressing force is applied from the stepped part 1s to the diaphragm member 20.

Herein, in the STEP4 of the present embodiment, a position control of the air suction part 1 is adopted, and a load feedback control is not executed.

In the present embodiment, subsequently to the above step, the controlling part 3 controls the robot arm mechanism 2 to rotate the diaphragm member 20 around the axis of the shaft part 32 of the diaphragm boss 30 in both reciprocal directions in a state wherein the axis of the columnar main body 23 of the diaphragm member 20 is conformed with the axis of the shaft part 32 of the diaphragm boss 30 (i.e., in a state wherein the tilting angel is 0 degrees) (STEP5). The reciprocal rotations are, for example, alternate ten half rotations, such as a (first) clockwise substantially half rotation, a (second) anticlockwise substantially half rotation, a (third) clockwise substantially half rotation, a (fourth) anticlockwise substantially half rotation, a (fifth) clockwise substantially half rotation, a (sixth) anticlockwise substantially half rotation, a (seventh) clockwise substantially half rotation, a (eighth) anticlockwise substantially half rotation, a (ninth) clockwise substantially half rotation and a (tenth) anticlockwise substantially half rotation.

Herein, in the STEP5 of the present embodiment, a load feedback control is executed, and thus the force applied from the stepped part 1s to the diaphragm member 20 is maintained to a predetermined value (for example 20 to 30 N, preferably 25 N).

In the present embodiment, subsequently to the above step, the controlling part 3 controls the robot arm mechanism 2 to tilt again the axis of the cylindrical main body 23 of the diaphragm member 20 with respect to the axis of the shaft part 32 of the diaphragm boss 30 (for example, the tilting angle therebetween is within 10 to 30 degrees, preferably 20 degrees), and to rotate the diaphragm member 20 around the axis of the shaft part 32 of the diaphragm boss 30 while maintaining the tilting angle formed therebetween (within such a conical surface) (STEP6). The rotation is, for example, clockwise substantially five rotations (substantially five laps).

Herein, in the STEP6 of the present embodiment as well, a load feedback control is executed, and thus the force applied from the stepped part 1s to the diaphragm member 20 is maintained to a predetermined value (for example 20 to 30 N, preferably 25 N).

In the present embodiment, subsequently to the above step, the controlling part 3 controls the robot arm mechanism 2 to rotate the diaphragm member 20 around the axis of the shaft part 32 of the diaphragm boss 30 in both reciprocal directions in a state wherein the axis of the columnar main body 23 of the diaphragm member 20 is conformed again with the axis of the shaft part 32 of the diaphragm boss 30 (i.e., in a state wherein the tilting angel has been returned to 0 degrees) (STEP7). The reciprocal rotations are, for example, alternate six half rotations, such as a (first) clockwise substantially half rotation, a (second) anticlockwise substantially half rotation, a (third) clockwise substantially half rotation, a (fourth) anticlockwise substantially half rotation, a (fifth) clockwise substantially half rotation and a (sixth) anticlockwise substantially half rotation.

Herein, in the STEP7 of the present embodiment as well, a load feedback control is executed, and thus the force applied from the stepped part 1s to the diaphragm member 20 is maintained to a predetermined value (for example 20 to 30 N, preferably 25 N).

The diaphragm member 20 and the diaphragm boss 30 fitted to each other as described above are shown in FIG. 9.

According to the robot arm apparatus 10 of the present embodiment as described above, since the diaphragm member 20 is held by making use of the air suction force, the diaphragm member 20 is surely held while avoiding any undesired deformation thereof.

In addition, according to the robot arm apparatus 10 of the present embodiment as described above, by bringing the small-diameter concave part 22 and/or the large-diameter concave part 21 of the diaphragm member 20 into contact with the enlarged-parameter part 31 of the diaphragm boss 30 while tilting the axis of the cylindrical main body 23 of the diaphragm member 20 with respect to the axis of the shaft part 32 of the diaphragm boss 30, and subsequently by pressing the small-diameter concave part 22 and/or the large-diameter concave part 21 of the diaphragm member 20 against the diaphragm boss 30 while rotating the small-diameter concave part 22 and/or the large-diameter concave part 21 of the diaphragm member 20 around the axis of the shaft part 32 of the diaphragm boss 30 (STEP4), it is possible to fit the enlarged-diameter part 31 into the large-diameter concave part 21 and to fit the shaft part 32 into the small-diameter concave part 22 while avoiding any undesired deformation of the diaphragm member 20 more surely.

In addition, according to the robot arm apparatus 10 of the present embodiment as described above, after the STEP4, the STEP5 is executed in which the diaphragm member 20 is rotated around the axis of the shaft part 32 of the diaphragm boss 30 in the both reciprocal directions in a state wherein the axis of the cylindrical main body 23 of the diaphragm member 20 is conformed with the axis of the shaft part 32 of the diaphragm boss 30. According to this step, the surface of the enlarged-diameter part 31 on the opposite side of the shaft part 32 can be brought into close contact with a surface of the large-diameter concave part 21 on the deeper side, which can make firmer the fitting between the diaphragm member 20 and the diaphragm boss 30.

In addition, according to the robot arm apparatus 10 of the present embodiment as described above, after the STEP5, the STEP6 is executed in which the axis of the cylindrical main body 23 of the diaphragm member 20 is tilted again with respect to the axis of the shaft part 32 of the diaphragm boss 30 and the diaphragm member 20 is rotated around the axis of the shaft part 32 of the diaphragm boss 30 while maintaining the tilting angle formed therebetween. According to this step, even when the fitting operation by the STEP4 and STEP5 does not function sufficiently, it is possible to fit the enlarged-diameter part 31 into the large-diameter concave part 21 and to fit the shaft part 32 into the small-diameter concave part 22 more surely.

In addition, according to the robot arm apparatus 10 of the present embodiment as described above, after the STEP6, the STEP7 is executed in which the diaphragm member 20 is rotated around the axis of the shaft part 32 of the diaphragm boss 30 in the both reciprocal directions in a state wherein the axis of the cylindrical main body 23 of the diaphragm member 20 is conformed again with the axis of the shaft part 32 of the diaphragm boss 30. According to this step, the surface of the enlarged-diameter part 31 on the opposite side of the shaft part 32 can be brought into close contact with the surface of the large-diameter concave part 21 on the deeper side, which can make firmer the fitting between the diaphragm member 20 and the diaphragm boss 30 (which is substantially the same effects as those by the STEP5).

In addition, according to the robot arm apparatus 10 of the present embodiment as described above, the air suction part 1 is configured to hold the diaphragm member 20 without any contact with the valve sealing surface 26. According to this feature, the valve sealing surface 26, which is important for the performances of the solenoid valve, can be maintained more surely in a state thereof just after the diaphragm member 20 has been finished.

In addition, according to the robot arm apparatus 10 of the present embodiment as described above, the air suction part 1 is configured to hold (the movable core 5 including) the diaphragm boss 30 without any contact with the surface of the enlarged-diameter part 31 on the opposite side of the shaft part 32. According to this feature, the surface of the enlarged-diameter part 31 on the opposite side of the shaft part 32, which is important for the firm fitting between the diaphragm member 20 and the diaphragm boss 30, can be maintained more surely in a state thereof just after the diaphragm boss 30 has been finished.

In addition, according to the robot arm apparatus 10 of the present embodiment as described above, it is possible to apply the pressing force against the diaphragm member 20 by making use of the stepped part 1s, and thus it is possible to fit the enlarged-diameter part 31 into the large-diameter concave part 21 and to fit the shaft part 32 into the small-diameter concave part 21 while avoiding any undesired deformation of the diaphragm member 20 more surely.

### EXPLANATION OF SIGN

1 air suction part
1a lower large-diameter hole
1b upper small-diameter hole
1c vertical hole
1d horizontal hole
1s stepped part
2 robot arm mechanism
3 controlling part
5 movable core
10 robot arm apparatus
20 diaphragm member
21 large-diameter concave part
22 small-diameter concave part
23 cylindrical main body
24 thinner curved part
25 thicker outer peripheral part
26 valve sealing surface
30 diaphragm boss (which is one part of movable core)
31 enlarged-diameter part
32 shaft part
40 ground
41 lower hanging-down part
110 solenoid valve main body
110a flow channel
110b flow channel
112 diaphragm seating surface
120 diaphragm member
121 large-diameter concave part
122 small-diameter concave part
123 cylindrical main body
124 thinner curved part
125 thicker outer peripheral part
130 diaphragm boss (which is one part of movable core)
131 enlarged-diameter part
132 shaft part

1. A method of attaching a diaphragm member to a diaphragm boss,
the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part;
the diaphragm boss including: a shaft part which is capable of fitting in the small-diameter concave part; and an enlarged-diameter part which is connected to the shaft part and is capable of fitting in the large-diameter concave part,
the method comprising:
(1) fixing the diaphragm boss in such a manner that the shaft part and the enlarged-diameter part are exposed upwardly,
(2) holding the diaphragm member with an air suction force by making use of a robot arm apparatus having an air suction part in such a manner that the small-diameter concave part and the large-diameter concave part are exposed downwardly,
(3) after the steps of (1) and (2), controlling the robot arm apparatus to bring the small-diameter concave part and/or the large-diameter concave part of the diaphragm member into contact with the enlarged-parameter part of the diaphragm boss while tilting an axis of the columnar main body of the diaphragm member with respect to an axis of the shaft part of the diaphragm boss, and
(4) after the step of (3), controlling the robot arm apparatus to press the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, so that the enlarged-diameter part is fitted into the large-diameter concave part and the shaft part is fitted into the small-diameter concave part.

2. The method according to claim 1, further comprising
(5) after the step of (4), controlling the robot arm apparatus to rotate the diaphragm member around the axis of the shaft part of the diaphragm boss in both reciprocal directions in a state wherein the axis of the columnar main body of the diaphragm member is conformed with the axis of the shaft part of the diaphragm boss.

3. The method according to claim 2, further comprising
(6) after the step of (5), controlling the robot arm apparatus to tilt again the axis of the columnar main body of the diaphragm member with respect to the axis of the shaft part of the diaphragm boss, and to rotate the diaphragm member around the axis of the shaft part of the diaphragm boss while maintaining a tilting angle formed therebetween.

4. The method according to claim 3, further comprising
(7) after the step of (6), controlling the robot arm apparatus to rotate the diaphragm member around the axis of the shaft part of the diaphragm boss in the both reciprocal directions in a state wherein the axis of the columnar main body of the diaphragm member is conformed again with the axis of the shaft part of the diaphragm boss.

5. The method according to claim 1, wherein
the diaphragm member has a valve sealing surface on an opposite side of the attaching surface side, and
the air suction part is configured to hold the diaphragm member without any contact with the valve sealing surface.

6. A robot arm apparatus configured to attach a diaphragm member to a diaphragm boss,
the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part;
the diaphragm boss including: a shaft part which is capable of fitting in the small-diameter concave part; and an enlarged-diameter part which is connected to the shaft part and is capable of fitting in the large-diameter concave part,
the robot arm apparatus comprising:
an air suction part capable of holding the diaphragm member with an air suction force in such a manner that the small-diameter concave part and the large-diameter concave part are exposed,
a robot arm mechanism connected to the air suction part and configured to change a position and a posture of the air suction part, and
a controlling part configured to control the robot arm mechanism,
the controlling part is capable of execute:
(3) controlling the robot arm mechanism to bring the small-diameter concave part and/or the large-diameter concave part of the diaphragm member into contact with the enlarged-parameter part of the diaphragm boss while tilting an axis of the columnar main body of the diaphragm member with respect to an axis of the shaft part of the diaphragm boss, and
(4) after the step of (3), controlling the robot arm mechanism to press the small-diameter concave part and/or the large-diameter concave part of the diaphragm member against the diaphragm boss while rotating the small-diameter concave part and/or the large-diameter concave part of the diaphragm member around the axis of the shaft part of the diaphragm boss, so that the enlarged-diameter part is fitted into the large-diameter concave part and the shaft part is fitted into the small-diameter concave part.

7. The robot arm apparatus according to claim 6, wherein
the controlling part is further capable of execute:
(5) after the step of (4), controlling the robot arm mechanism to rotate the diaphragm member around the axis of the shaft part of the diaphragm boss in both reciprocal directions in a state wherein the axis of the columnar main body of the diaphragm member is conformed with the axis of the shaft part of the diaphragm boss.

8. The robot arm apparatus according to claim 7, wherein
the controlling part is further capable of execute:
(6) after the step of (5), controlling the robot arm mechanism to tilt again the axis of the columnar main body of the diaphragm member with respect to the axis of the shaft part of the diaphragm boss, and to rotate the diaphragm member around the axis of the shaft part of the diaphragm boss while maintaining a tilting angle formed therebetween.

9. The robot arm apparatus according to claim 8, wherein
the controlling part is further capable of execute:
(7) after the step of (6), controlling the robot arm mechanism to rotate the diaphragm member around the axis of the shaft part of the diaphragm boss in the both reciprocal directions in a state wherein the axis of the columnar main body of the diaphragm member is conformed again with the axis of the shaft part of the diaphragm boss.

10. The robot arm apparatus according to claim 6, wherein
the diaphragm member has a valve sealing surface on an opposite side of the attaching surface side, and
the air suction part is configured to hold the diaphragm member without any contact with the valve sealing surface.

11. The robot arm apparatus according to claim 6, wherein
the air suction part is configured to hold the diaphragm boss without any contact with a surface of the enlarged-diameter part on the opposite side of the shaft part.

12. A robot arm apparatus configured to attach a diaphragm member to a diaphragm boss,
the diaphragm member including: a columnar main body; and a thinner curved part which is annularly provided on an outer side than the columnar main body; wherein the columnar main body is provided with a small-diameter concave part on an attaching surface side and a large-diameter concave part on a side deeper than the small-diameter concave part;
the diaphragm boss including: a shaft part which is capable of fitting in the small-diameter concave part; and an enlarged-diameter part which is connected to the shaft part and is capable of fitting in the large-diameter concave part,
the robot arm apparatus comprising:
an air suction part capable of holding the diaphragm member with an air suction force in such a manner that the small-diameter concave part and the large-diameter concave part are exposed,
a robot arm mechanism connected to the air suction part and configured to change a position and a posture of the air suction part, and
a controlling part configured to control the robot arm mechanism,
wherein
the air suction part has a lower large-diameter hole and an upper small-diameter hole, which are continuous in a height direction thereof via a stepped part,
the diaphragm member is configured to be held with the air suction force in such a manner that the columnar main body is received in the lower large-diameter hole, and
the diaphragm member is configured to be in contact with the stepped part in a state wherein the diaphragm member is held with the air suction force.
